(19) United States
(12) Patent Application Publication
(10) Pub. No.: US 2005/0060150 A1
(43) Pub. Date: Mar. 17, 2005

(54) Unsupervised training for overlapping ambiguity resolution in word segmentation

(75) Inventors: Mu Li, Beijing (CN); Jianfeng Gao, Beijing (CN)

Correspondence Address: Linda P. Ji;Westman, Champlin & Kelly, Suite 1600, 900 Second Avenue South, Minneapolis, MN, 55402-3319, US

(73) Assignee: Microsoft Corporation, Redmond, WA (US)

(21) Appl. No.: 10/662,502

(22) Filed: Sep. 15, 2003

(51) Int. Cl. G10L 15/00

(52) U.S. Cl. 704/240

(57) ABSTRACT

A method for resolving overlapping ambiguity strings in unsegmented languages such as Chinese. The methodology includes segmenting sentences into two possible segmentations and recognizing overlapping ambiguity strings in the sentences. One of the two possible segmentations is selected as a function of probability information. The probability information is derived from unsupervised training data. A method of constructing a knowledge base containing probability information needed to select one of the segmentation is also provided.

### BACKGROUND OF THE INVENTION

The present invention relates generally to the field of natural language processing. More specifically, the present invention relates to word segmentation.

Word segmentation refers to the process of identifying individual words that make up an expression of language, such as in written text. Word segmentation is useful for checking spelling and grammar, synthesizing speech from text, speech recognition, information retrieval, and performing natural language parsing and understanding.

English text can be segmented in a relatively straight-forward manner because spaces and punctuation marks generally delineate individual words in the text. However, in Chinese character text, boundaries between words are implicit rather than explicit. Thus, a Chinese word can comprise one character or a string of two or more characters, with the average Chinese word comprising approximately 1.6 characters. A fluent reader of Chinese would naturally delineate or segment Chinese character text into individual words in order to comprehend the text.

However, there can be inherent ambiguity within Chinese character text. One type of ambiguity is known as overlapping ambiguity. A second type has been called combination or covering ambiguity. Overlapping ambiguity results when strings of Chinese characters can be segmented in more than one way depending on context. In other words, Chinese language character strings can have “overlapping ambiguity.”

For example, consider the Chinese character string “ABC” where “A”, “B”, and “C” are Chinese characters. An overlapping ambiguity results when the string “ABC” can be segmented as “AB/C” or “A/BC” because each of “AB”, “C”, “A”, and “BC” are recognized as Chinese words. The fluent reader would naturally resolve the overlapping ambiguity string (OAS) “ABC” by considering context features such as Chinese characters to the left and right of the OAS.

The research community has devoted considerable resources to develop methods that more accurately resolve overlapping ambiguities. Generally, these methods can be grouped into either rule-based or statistical approaches.

One relatively simple rule-based method is known as Maximum Matching (MM) segmentation. In MM segmentation, the segmentation process starts at the beginning or the end of a sentence, and sequentially segments the sentence into words having the longest possible character strings or sequences. The segmentation continues until the entire sentence has been processed. Forward Maximum Matching (FMM) segmentation is MM segmentation that starts at the beginning of the sentence, while Backward Maximum Matching (BMM) segmentation is MM segmentation that starts at the end of the sentence. Although both FMM and BMM segmentation methods have been widely used due to their simplicity, they have been found to be rather inaccurate with Chinese text. Other rule-based methods have also been developed but such methods generally require skilled linguists to develop suitable segmentation rules.

In contrast to rule-based methods, statistical methods view resolving overlapping ambiguities as a search or classification task based on probabilities. However, prior art statistical methods generally require a large manually labeled training set which is not always available. Also, developing such a training set is relatively expensive due to the large amount of human resources needed to manually annotate or label linguistic training data.

Unfortunately, there can be limitations to a machine's ability to resolve OASs as accurately as human readers. It has been estimated that overlapping ambiguities are responsible for approximately 90% of errors resulting from segmentation ambiguity. Therefore, an approach that performs segmentation that automatically resolves overlapping ambiguity strings in an accurate and efficient manner would have significant utility for Chinese as well as other unsegmented languages.

### SUMMARY OF THE INVENTION

A method for resolving overlapping ambiguity strings in unsegmented languages such as Chinese. The methodology includes segmenting sentences into two possible segmentations and recognizing overlapping ambiguity strings in the sentences. One of the two possible segmentations is selected as a function of probability information. The probability information is derived from unsupervised training data. A method of constructing a knowledge base containing probability information needed to select one of the segmentation is also provided.

### BRIEF DESCRIPTION OF THE DRAWINGS

FIG. 1 is a block diagram of one computing environment in which the present invention may be practiced.

FIG. 2 is a block diagram of an alternative computing environment in which the present invention may be practiced.

FIG. 3 is an overview flow diagram illustrating two aspects of the present invention.

FIG. 4 is a block diagram of a system for augmenting a lexical knowledge base.

FIG. 5 is a block diagram of a system for performing word segmentation.

FIG. 6 is a flow diagram illustrating augmentation of the lexical knowledge base.

FIG. 7 is a flow diagram illustrating word segmentation.

FIG. 8 is a pictorial representation of a classifier ensemble.

### DETAILED DESCRIPTION OF ILLUSTRATIVE EMBODIMENTS

One aspect of the present invention provides a hybrid method (both rule-based and statistical) for resolving overlapping ambiguities in word segmentation. The present invention is relatively economical because trained linguists are not needed to formulate segmentation rules are not needed. Further, the present invention utilizes unsupervised training so human resources spent developing a large manually labeled training set are unnecessary.

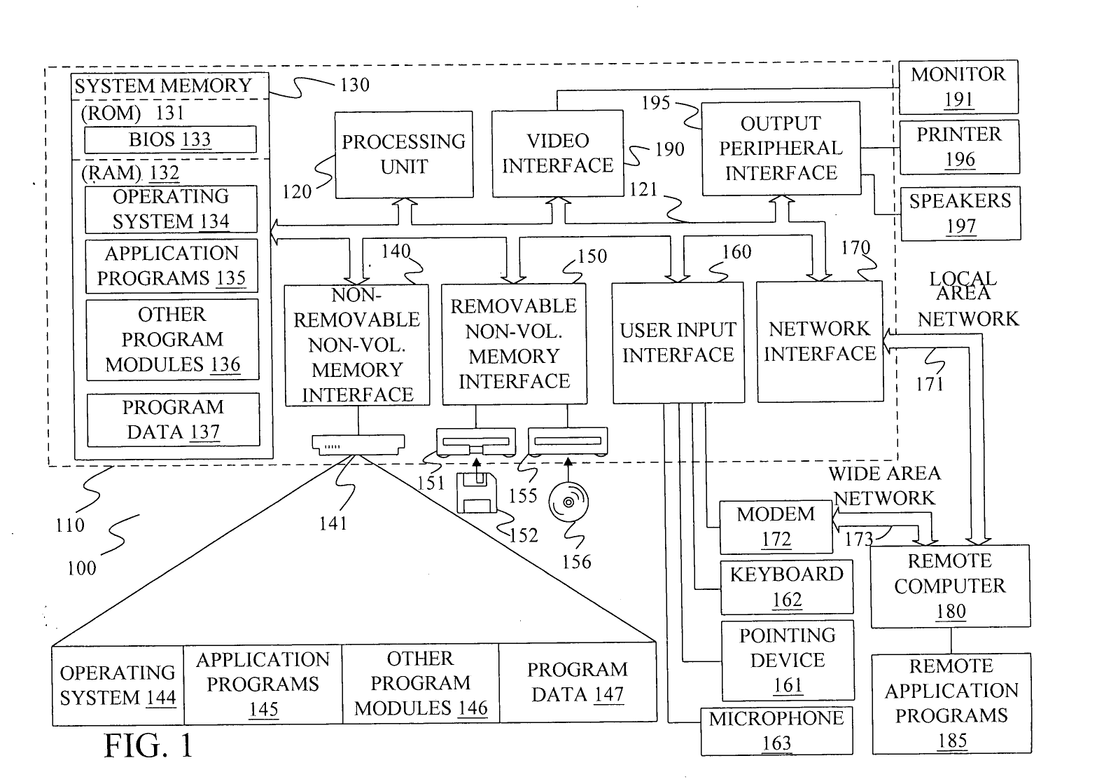

Before addressing further aspects of the present invention, it may be helpful to describe generally computing devices that can be used for practicing the invention. Referring to FIG. 1, illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCS, minicomputers, mainframe computers, telephone systems, distributed computing environments that include any of the above systems or devices, and the like.

The invention may be described in the general context of computer-executable instructions, such as program modules, being executed by a computer. Generally, program modules include routines, programs, objects, components, data structure, etc. that perform particular tasks or implement particular abstract data types. Tasks performed by the programs and modules are described below and with the aid of figures. Those skilled in the art can implement the description and/or figures herein as computer-executable instructions, which can be embodied on any form of computer readable media discussed below.

The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general-purpose computing device in the form of a computer 110. Components of computer 110 may include, but are not limited to, a processing unit 120, an system memory 130, and a system bus 121 that couples various system components including the system memory to the processing unit 120. the system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standard Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and non-volatile media, removable and non-removable media. By way of example, and not limitation, computer readable media may comprise computer storage media and communication media. Computer storage media includes both volatile and non-volatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or non-volatile memory such as read only memory (ROM) 131 and random access memory (RAM) 132. A basic input/output system 133 (BIOS), containing the basic routines that help to transfer information between elements within computer 110, such as during start-up is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, and volatile/non-volatile computer storage media. By way of example only, FIG. 1 illustrates a hard disk drive 141 that reads from or writes to non-removable, non-volatile magnetic media, a magnetic disk drive 151 that reads from or writes to a removable, non-volatile magnetic disk 152, and an optical disk drive 155 that reads from or writes to a removable, non-volatile optical disk 156 such as a CD ROM or other optical media. Other removable/non-removable, volatile/non-volatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are give different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structure, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

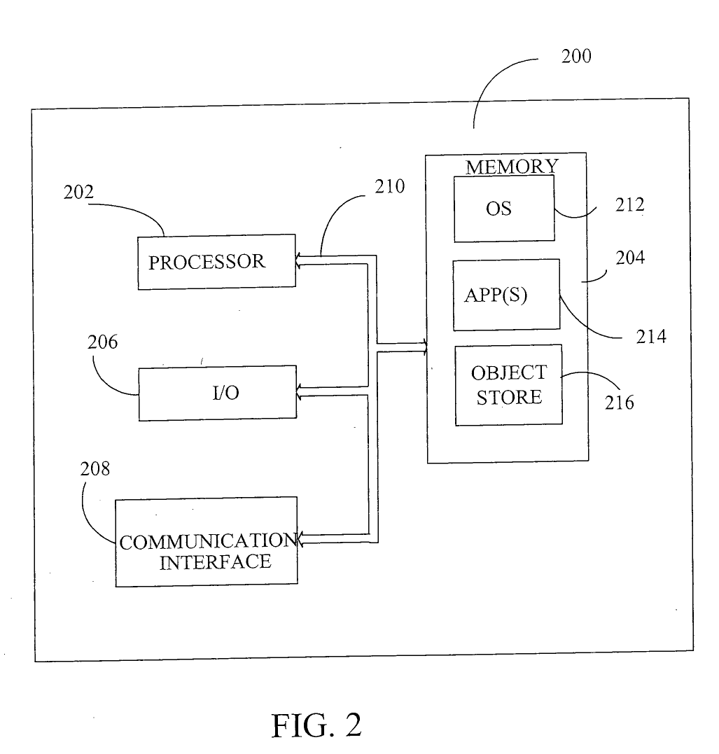

FIG. 2 is a block diagram of a mobile device 200, which is another exemplary computing environment. Mobile device 200 includes a microprocessor 202, memory 204, input/output (I/O) components 206, and a communication interface 208 for communicating with remote computers or other mobile devices. In one embodiment, the afore-mentioned components are coupled for communication with one another over a suitable bus 210.

Memory 204 is implemented as non-volatile electronic memory such as random access memory (RAM) with a battery back-up module (not shown) such that information stored in memory 204 is not lost when the general power to mobile device 200 is shut down. A portion of memory 204 is preferably allocated as addressable memory for program execution, while another portion of memory 204 is preferably used for storage, such as to simulate storage on a disk drive.

Memory 204 includes an operating system 212, application programs 214 as well as an object store 216. During operation, operating system 212 is preferably executed by processor 202 from memory 204. Operating system 212, in one preferred embodiment, is a WINDOWS® CE brand operating system commercially available from Microsoft Corporation. Operating system 212 is preferably designed for mobile devices, and implements database features that can be utilized by applications 214 through a set of exposed application programming interfaces and methods. The objects in object store 216 are maintained by applications 214 and operating system 212, at least partially in response to calls to the exposed application programming interfaces and methods.

Communications interface 208 represents numerous devices and technologies that allow mobile device 200 to send and receive information. The devices include wired and wireless modems, satellite receivers and broadcast tuners to name a few. Mobile device 200 can also be directly connected to a computer to exchange data therewith. In such cases, communication interface 208 can be an infrared transceiver or a serial or parallel communication connection, all of which are capable of transmitting streaming information.

Input/output components 206 include a variety of input devices such as a touch-sensitive screen, buttons, rollers, and a microphone as well as a variety of output devices including an audio generator, a vibrating device, and a display. The devices listed above are by way of example and need not all be present on mobile device 200. In addition, other input/output devices may be attached to or found with mobile device 200 within the scope of the present invention.

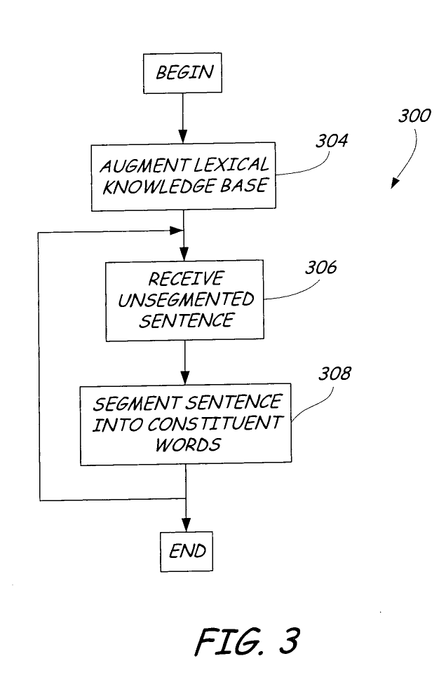

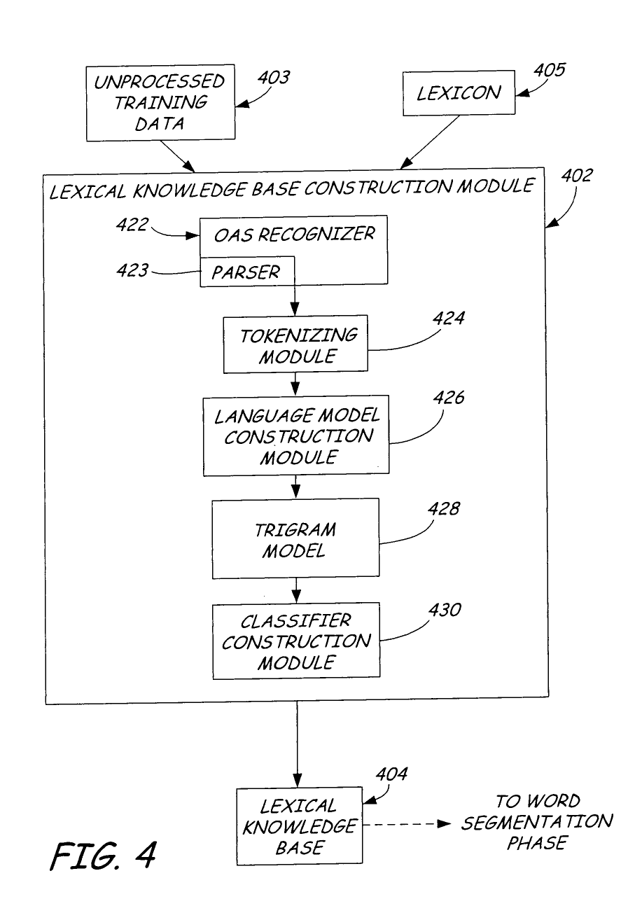

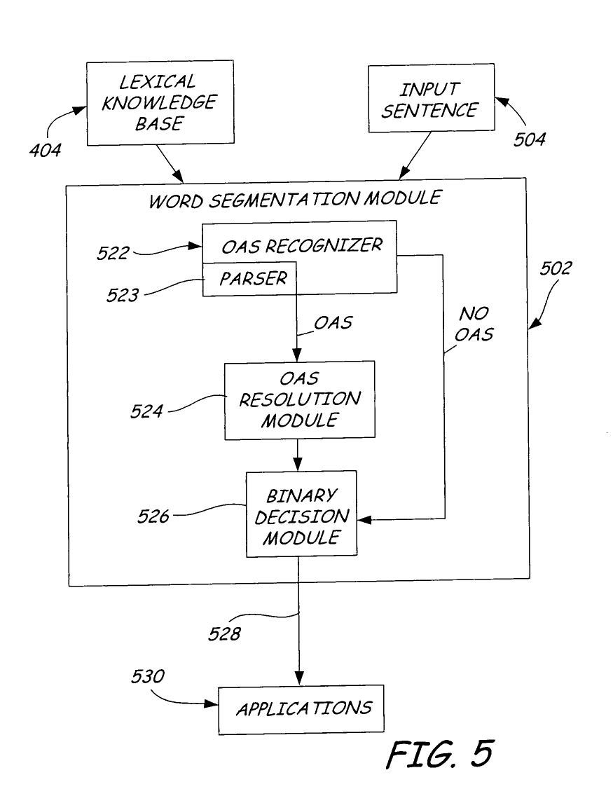

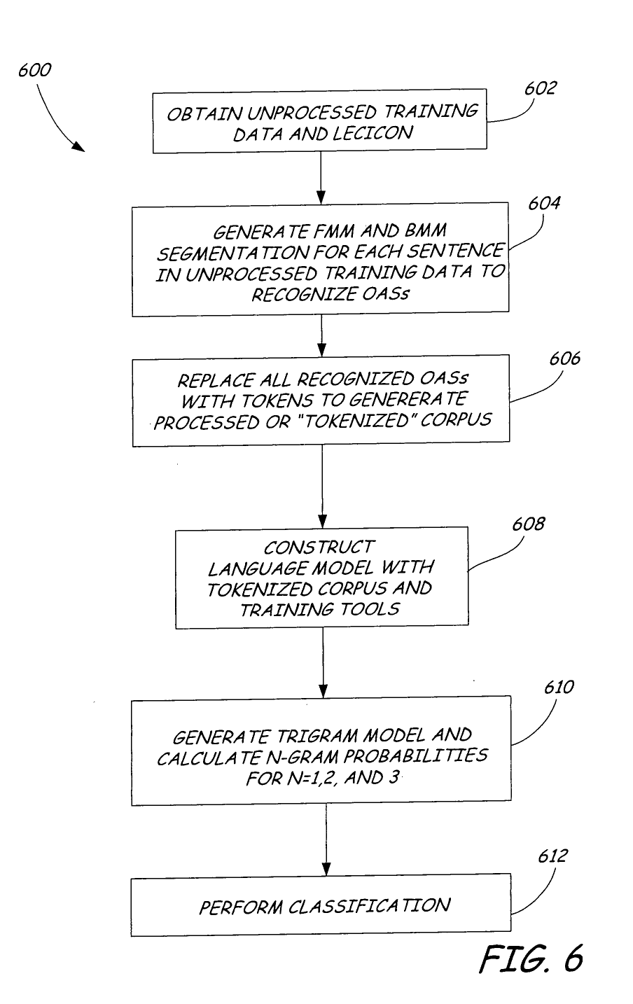

FIG. 3 is an overview flow diagram showing two aspects of the present invention embodied as a single method 300. FIGS. 4 and 5 are block diagrams illustrating modules for performing each of the aspects. Referring to FIGS. 3 and 4, a lexical knowledge base construction module 402 augments or provides a lexical knowledge base 404 to include information used later to perform word segmentation that resolves overlapping ambiguities. The lexical knowledge base construction module 402 performs step 304 to augment the lexical knowledge base 404 in method 300. Step 304 is discussed in greater detail below in conjunction with FIGS. 6A-6C.

Briefly, in step 304, the lexical knowledge base construction module 402 can augment lexical knowledge base 404 with information such as OAS data; processed training data or “tokenized” corpus; a language model needed to calculate N-gram probabilities such as trigram probabilities; and classifiers, such as Naïve Bayesian Classifiers. The lexical knowledge base construction module 402 receives input data, such as a lexicon 405 and unprocessed training data 403 necessary to augment the lexical knowledge base 404 from any of the input devices described above as well as from any of the data storage devices described above.

The lexical knowledge base construction module 402 can be an application program 135 executed on computer 110 or stored and executed on any of the remote computers in the LAN 171 or the WAN 173 connections. Likewise, the lexical knowledge base 404 can reside on computer 110 in any of the local storage devices, such as hard disk drive 141, or on an optical CD, or remotely in the LAN 171 or the WAN 173 memory devices.

As illustrated in FIG. 4, training data 403 can be processed by OAS recognizer 422 and tokenizing module 424. The OAS recognizer 422 includes parser 423 that consults lexicon 405 illustrated in FIG. 4 to perform segmentations, such as FMM and BMM segmentations of sentences, of unprocessed or raw training data 403. Unprocessed training data 403 can be obtained from sources such as publications and the web. The OAS recognizer 422 recognizes OASs based on information derived from segmentations, i.e., the FMM and BMM segmentations of sentences, and lexicon 405.

A sentence contains an OAS when the FMM and BMM segmentations of the OAS are different. For example, consider a string “ABC” such as “ [symbol] ”. In some situations, an FMM segmentation yields “A/BC” or “ [symbol] ” while the BMM segmentation yields “AB/C” or “ [symbol] ” In this illustrative example, since the FMM segmentation and the BMM segmentation of string “ABC” are not the same, the string “ABC” is recognized as an OAS. Also, the FMM segmentation of “ABC” or “A/BC” (herein also referred to as “O_{f}”) and the BMM segmentation “AB/C” (herein also referred to as “O_{b}”). When the string is an OAS, then O_{f} is not equal to O_{b}.

The OAS recognizer 422 thus is adapted to recognize OASs, especially the longest OAS in each sentence. For example, consider a sentence containing a Chinese character string “ABCD” where “A”, “B”, “C”, and “D” are Chinese characters. There are situations where both “ABC” such as “ [symbol] ” and “ABCD” such as “ [symbol] ” are OASs. In this and similar situations, the string “ABCD” or “ [symbol] ” would be recognized as the longest OAS.

Tokenizing module 424 replaces the longest recognized OASs of the unprocessed training data 403 with tokens to yield processed training data or a “tokenized” corpus. For instance, each token can be expressed as “[OAS]”. For example, consider the unprocessed Chinese sentence:
[symbol] [symbol] input as unprocessed training data to lexical knowledge base construction module 402. After processing by OAS recognizer module 422 and tokenizing module 424, the processed sentence is:
[symbol] [OAS] [symbol]
   where the string “ [symbol] ” has been replaced by the designator [OAS]. Such processed sentences make up the tokenized corpus.

Tokenized corpus is then used by language model construction module 426 to construct statistical language models. One exemplary type of statistical language model is a trigram model 428. It should be restated that language model construction module 426 can be adapted to calculate N-gram probabilities such as unigrams, bigrams, etc. for individual and combinations of words found in the tokenized corpus. It is noted that construction of statistical language models for Chinese using various training tools is discussed in the publication “Toward a Unified Approach to Statistical Language Modeling for Chinese,” ACM Transactions on Asian Language Information Processing, 1(1):3-33 (2002) by Jianfeng Gao, Joshua Goodman, Mingjing Li, and Fai-fu Lee, and is herein incorporated by reference.

At this point, it should be noted that although OASs have been removed from the tokenized corpus, the constituent words of the OASs have not been removed. In the tokenized corpus, the OAS string “ABC” such as “ [symbol] ”. has been removed. However, the constituent lexical words “AB”, “C”, “A”, and “BC” or “ [symbol] ”, “ [symbol] ”, “ [symbol] ” and “ [symbol] ”, respectively, remain in the tokenized corpus. This distinction becomes relevant in resolving OASs during the word segmentation phase of actual input sentences, especially in calculating N-gram (e.g. trigram) probabilities, and is discussed in greater detail below.

It was noted above that one type of statistical language model is the trigram model which is constructed at trigram model construction module 428. Trigram models can be used to determine the statistical probability that a third word follows two existing words. A trigram model can also determine the probability that a string of three words exists within the processed training corpus. Trigram probabilities are useful in computing a classifier and/or constructing an ensemble of classifiers used to resolve OASs within OAS resolution module 524 shown in FIG. 5 and discussed in more detail below.

The language model 428 created by language model construction module 426 and classifiers and ensembles of classifiers constructed by classifier construction module 430 can be stored in lexical knowledge base 404. The classifiers and ensembles of classifiers can also be computed and constructed in the word segmentation phase based on probabilities, such as N-gram probabilities, stored in lexical knowledge base 404 as is understood by those skilled in the art.

Although there are other suitable classifiers, Naïve Bayesian Classifiers, which are based on conditional independence principles, have been found useful in resolving OASs in unsegmented languages such as Chinese. The publication “A Simple Approach to Building Ensembles of Naïve Bayesian Classifiers for Word Sense Disambiguation,” by Ted Pederson from, In Proceedings of the First Annual Meeting of the North American Chapter of the Association for Computational Linguistics, Seattle, Wash., pp. 63-69 (2000), provides an illustrative methodology of constructing ensembles of Naïve Bayesian Classifiers for English, and is herein incorporated by reference.

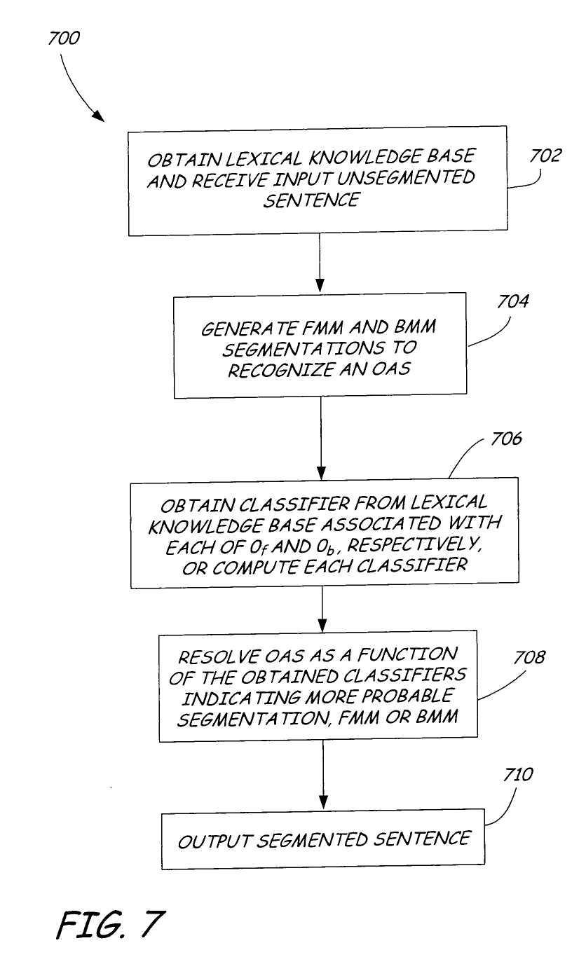

Referring back to FIG. 3, after step 304, ending the initialization phase, the word segmentation phase begins. Referring to FIGS. 3 and 5, in the word segmentation phase, word segmentation module 502 performs step 308 of method 300. Word segmentation module 502 uses information stored in lexical knowledge base 404 that has been augmented by lexical knowledge base construction module 402 to perform segmentation of sentences of unsegmented languages. Using, by way of example, Chinese as an unsegmented language, the word segmentation module 502 receives input text, typically in the form of a written or spoken sentence, at step 306 shown in FIG. 3. At step 308, the word segmentation module 508 segments the received text or sentence into its constituent words, while resolving any OAS recognized in the input sentence 504. Step 308 is discussed in greater detail in conjunction with the flowchart shown in FIG. 7.

Briefly, the word segmentation module 508 recognizes OASs and resolves them by choosing the more probable of two OAS segmentations, O_{f} or O_{b}. Thus, resolving the overlapping ambiguity string in Chinese segmentation can be viewed as a binary classification problem between the FMM segmentation O_{f} and the BMM segmentation O_{b} of a given OAS. Therefore, given a longest OAS “O” and its context feature set C, G(Seg, C) is a score (or probability) function of Seg for Seg ε {O_{f}, O_{b}}. Thus, the overlapping ambiguity resolution task is to make the binary decision shown in equation 1:

$$seg = \{ \begin{matrix}{O}_{f} & G ( {O}_{f} , C ) > G ( {O}_{b} , C ) \\ {O}_{b} & G ( {O}_{f} , C ) < G ( {O}_{b} , C )\end{matrix} \qquad ( 1 )$$

Note that O_{f}=O_{b} means that both FMM and BMM arrive at the same result. The classification process can then be stated as:
a) If O_{f}=O_{b}, then chose either segmentation result since they are the same.
b) Otherwise, choose the segmentation with the higher G score according to Equation 1.

Referring back to FIG. 5, word segmentation module 502 includes OAS recognizer module 522 that comprises parser 523 that together can segment and recognize an OAS in input sentences in a manner similar to OAS recognizer module 422 and parser 423 shown in FIG. 4. In alternate embodiments, OAS recognizer module 522 can recognize an OAS in an input sentence from a database of OASs stored on lexical knowledge base 404 as is understood by those skilled in the art.

If OAS recognizer module 522 determines that there is no OAS in the sentence, then the word segmentation process proceeds to binary decision module 526. However, if OAS recognizer 522 determines that an OAS is present in the input sentence, the method proceeds to OAS resolution module 524.

OAS resolution module 524 determines the more probable of the FMM and BMM segmentations as a function of their G scores described in greater detail below in FIGS. 6A-6C and FIG. 7. The G score for both the FMM and BMM segmentations can be determined based on context words to the left (preceding) and right (succeeding) of their respective OAS segmentations, O_{f} and O_{b}. The present invention utilizes Naïve Bayesian Classifiers as the G function with variables comprising context features (e.g. up to two words left and right of the OAS), and OAS segmentation (i.e. O_{f} or O_{b}).

Binary decision module 526 decides which segmentation should be selected between the two possibilities, the FMM or BMM segmentation of a particular sentence. When no OAS has been recognized, either the FMM or BMM segmentation can be selected because they are the same. However, if an OAS was recognized in the input sentence, the binary decision module 526 selects the FMM or BMM segmentation based on which has a higher G score. Segmented sentences selected by binary decision module 526 can be provided at output 528 and used in various applications 530 such as but not limited to word segmentation that is useful for checking spelling and grammar, synthesizing speech from text, speech recognition, information retrieval, and performing natural language parsing and understanding to name a few.

FIG. 6 comprises a flow diagram 600 showing exemplary steps for augmenting the lexical knowledge base 404 shown in FIG. 4 during the initialization phase to include information used to perform word segmentation. Generally, step 602 and step 604 together can process unprocessed lexical training data into processed training data, also called a “tokenized” corpus. At step 602, unprocessed training data and lexicon is obtained or received. At step 604, FMM and BMM segmentations of sentences in the training data are generated by known methods. From these generated FMM and BMM segmentations, OASs in the training data are identified or recognized. At step 606, recognized OASs are removed and replaced by tokens to a construct tokenized corpus. Since OASs are associated with segmentation errors and have been removed, tokenized corpus can be used to construct more accurate language model, such as a trigram model.

At step 608, language models are constructed or generated using tokenized corpus and various training tools. At step 610, a trigram model of tokenized corpus is constructed or generated. Trigram models can be adapted to calculate and store data indicative of N-gram probabilities, including unigram, bigram, and trigram probabilities for individual words or combinations of two or three words.

At step 612, classifier construction module 430 formulates the overlapping ambiguity resolution of an OAS O as a binary classification. An adapted Naïve Bayesian Classifier (NBC) is used as score function G introduced in equation 1. In the framework of NBCs, context words C forming a set of context words to the left and right of OAS O, can be used in determining G score. One characteristic of NBCs is that they assume that feature variables are conditionally independent. Thus, NBCs can be used to approximate joint probability of Seg, left context words, C₋ₘ, . . . , C₋₁, and right context words, C₁, . . . , Cₙ. In other words, the NBC ensemble can provide a mechanism for determining probability that a particular OAS segmentation occurs with a particular set of context words left and right of the OAS segmentation. This concept can be mathematically expressed in equation 2 below:

$$\begin{matrix}\begin{matrix}p ( {C}_{- m} , … , {C}_{- 1} , \\ {C}_{1} , … , {C}_{n} , Seg )\end{matrix} = p ( Seg ) p \\ ( {C}_{- m} , … , {C}_{- 1} , {C}_{1} , … , {C}_{n} \vert Seg ) \\ = p ( Seg ) {\prod }_{i = - m , … , - 1 , 1 , … , n} p ( {C}_{i} \vert Seg ) .\end{matrix} \qquad ( 2 )$$

It is noted that because all OASs including Seg have been removed from the tokenized corpus, there is no statistical information available to estimate p(Seg) or p(C₋ₘ, . . . , C₋₁, C₁, . . . , Cₙ|Seg) based on Maximum Likelihood Estimation (MLE) principle. Thus, two assumptions are made.

The first assumption can be expressed as: Since the unigram probability of each word w can be estimated from the training data for a given segmentation w=wₛ_{ₗ}, . . . , wₛ_{ₖ}, it is assumed that each word w of Seg is generated independently. Thus, the probability p(Seg) in equation 1 is approximated by the production of word unigram probabilities and is shown in equation 3:

$$p ( Seg ) = {\prod }_{{w}_{{s}_{1}} ∈ Seg} p ( {w}_{{s}_{i}} ) \qquad ( 3 )$$

The second assumption can be expressed as: Assume that left and right context word sequences are only conditioned on the leftmost and rightmost words of Seg, respectively, as shown in equation 4:

$$\begin{matrix}p ( {C}_{- m} , … {C}_{- 1} , {C}_{1} , … , {C}_{n} \vert Seg ) = p ( {C}_{- m} , … , {C}_{- 1} \vert {C}_{{s}_{1}} ) p \\ ( {C}_{1} , … , {C}_{n} \vert {w}_{{s}_{k}} ) \\ = \frac{\begin{matrix}p ( {C}_{- m} , … , {C}_{- 1} , {C}_{{s}_{1}} ) p \\ ( {C}_{{s}_{k}} , {C}_{1} , … , {C}_{n} )\end{matrix}}{p ( {w}_{{s}_{1}} ) p ( {w}_{{s}_{k}} )}\end{matrix} \qquad ( 4 )$$

Thus, equation 2 equals the product of equations 3 and 4. For the sake of clarity, equation 2 has been re-written to show how an ensemble of Naïve Bayesian Classifiers can be assembled and is given by equation 5:

$$\begin{matrix}NBC ( m , n ) = {\prod }_{{w}_{{s}_{i}} ∈ Seg} p ( {w}_{{s}_{i}} ) \\ \frac{p ( {C}_{- m} , … , {C}_{- 1} , {w}_{{s}_{1}} ) p ( {w}_{{s}_{k}} , {C}_{1} , … , {C}_{n} )}{p ( {w}_{{s}_{1}} ) p ( {w}_{{s}_{k}} )}\end{matrix} \qquad ( 5 )$$

where m and n are the window sizes left and right of the OAS, respectively.

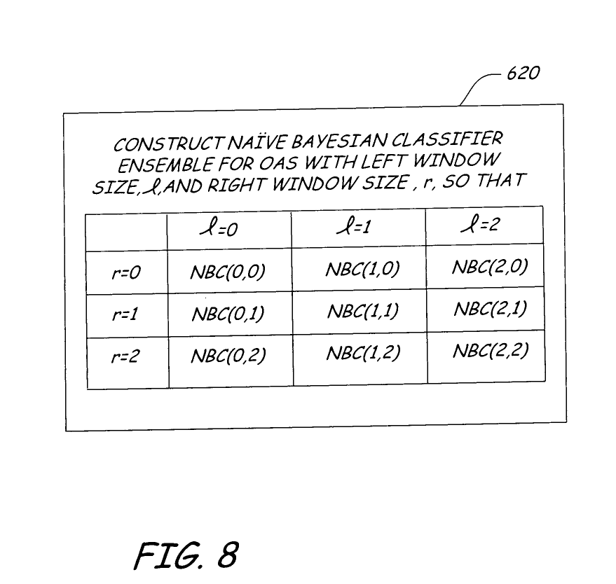

FIG. 8 illustrates a general ensemble 620 of Naïve Bayesian Classifiers with window size up to 2 is shown. Thus, the ensemble 620 has 9 classifiers, each of which can be computed with the above equation 5. Some embodiments of the present invention use “majority” vote or the segmentation, FMM or BMM, selected by most of the classifiers to perform the step of resolving the OAS such as illustrated as step 708 in FIG. 7 discussed below.

In some embodiments ensembles of NBCs generated from unigram probabilities of OAS constituent words wₛ_{ₗ}, . . . , wₛ_{ₓ} and bigram and trigram probabilities of word combinations having Wₛ_{ₗ} or Wₛ_{ₖ} that exist in the tokenized corpus are stored in lexical knowledge base 404 shown in FIG. 4. It was noted earlier that although OASs have been removed from the tokenized corpus, that their constituent words remain. Thus, it is possible to obtain probability information regarding the constituent words of the OAS in the tokenized corpus. Also, those skilled in the art will readily recognize that classifiers ensembles NBC(m,n), for example up to a window size of 2 or m=n=2, can be stored in lexical knowledge base 404 in suitable data structures, or alternately, generated in the word segmentation phase of method 300 from stored unigram, bigram, and trigram probabilities.

FIG. 7 is a flow diagram 700 illustrating word segmentation. Step 702 comprises obtaining information from the lexical knowledge base 404. Step 702 further comprises receiving an actual unsegmented input sentence 504. At step 704, input sentence 504 is segmented to generate an FMM and BMM segmentation to recognize whether input sentence 504 contains an OAS. Step 716 comprises obtaining a classifier from lexical knowledge base 404 or alternately computing a classifier from information stored on lexical knowledge base 404. Step 708 comprises resolving the OAS based on G scores for the O_{f} and O_{b} segmentations of the OAS.

For a simple illustration of steps 706 and 708 in an embodiment of the present invention, assume an input sentence contains the word string segmentation, “C₁/C₂/A/BC/C₃/C₄” where “C₁”, “C₂”, “A”, “BC”, “C₃”, and “C₄” are Chinese words and “A/BC” is O_{f}, or the FMM segmentation of OAS “ABC”. Also, assume that we want to know the NBC value or G score for the segmentation, “A/BC” (which importantly comprises two words only), and two context words to the left and right of the OAS. Thus, the left window size m=2 and the right window size n=2, and equation 5 simplifies to:
NBC(2,2)=p(C₁, C₂, A)p(BC, C₃, C₄) (6)
where p(C₁, C₂, A), and p(BC, C₃, C₄) are word trigram probabilities that were generated by the language construction module 426 shown in FIG. 4. Next, assuming O_{b} equals “AB/C” and the left and right window sizes again equal two, the NBC value or G score can be expressed as:
NBC(2,2)=p(C₁, C₂, AB)p(C, C₃, C₄) (7)
which is again a product of two trigram probabilities generated by the language construction module 426. Thus, applying equation 1 above, and assuming that only one classifier, NBC(2,2) is consulted, the FMM segmentation is selected when the NBC value in equation 6 is greater than the NBC value in equation 7. In contrast, the BMM segmentation is selected when the NBC value in equation 6 is less than the NBC value of equation 7. Alternately, an ensemble 620 of classifiers (e.g. 9 classifiers) can use “majority” vote to resolve the OAS ambiguity as discussed above.

Although the present invention has been described with reference to particular embodiments, workers skilled in the art will recognize that changes may be made in form and detail without departing from the spirit and scope of the invention.

1. A computer readable medium including instructions readable by a computer which, when implemented, cause the computer to resolve an overlapping ambiguity string in an input sentence of an unsegmented language by performing steps comprising:
segmenting the sentence into two possible segmentations;
recognizing the overlapping ambiguity string in the input sentence as a function of the two segmentations; and
selecting one of the two segmentations as a function of probability information for the two segmentations.

2. The computer readable medium of claim 1 and further comprising obtaining the probability information from a lexical knowledge base.

3. The computer readable medium of claim 2 wherein the lexical knowledge base comprises a trigram model.

4. The computer readable medium of claim 2 wherein selecting one of the two segmentations comprises classifying the probability information.

5. The computer readable medium of claim 4 wherein classifying comprises classifying using Naïve Bayesian Classification.

6. The computer readable medium of claim 1 wherein segmenting the sentence comprises performing a Forward Maximum Matching (FMM) segmentation of the input sentence and a Backward Maximum Matching (BMM) segmentation of the input sentence.

7. The computer readable medium of claim 6 wherein recognizing the overlapping ambiguity string comprises recognizing a segmentation O_{f} of the overlapping ambiguity string from the FMM segmentation and a segmentation O_{b} of the overlapping ambiguity string from the BMM segmentation.

8. The computer readable medium of claim 7 wherein selecting one of the two segmentations is a function of a set of context features associated with the overlapping ambiguity string.

9. The computer readable medium of claim 8 wherein the set of context features comprises words around the overlapping ambiguity string.

10. The computer readable medium of claim 8 wherein selecting one of the two segmentations comprises classifying the probability information of the set of context features and O_{f}.

11. The computer readable medium of claim 10 wherein selecting one of the two segmentations comprises classifying the probability information of the set of context features and O_{b}.

12. The computer readable medium of claim 8 wherein selecting comprising determining which of O_{f} or O_{b} has a higher probability as a function of the set of context features.

13. The computer readable medium of claim 1 wherein the unsegmented language is Chinese.

14. A method of segmentation of a sentence of an unsegmented language, the sentence having an overlapping ambiguity string (OAS), the method comprising the steps of:
generating a Forward Maximum Matching (FMM) segmentation of the sentence;
generating a Backward Maximum Matching (BMM) segmentation of the sentence;
recognizing an OAS as a function of the FMM and the BMM segmentations; and
selecting one of the FMM segmentation and the BMM segmentation as a function of probability information.

15. The method of claim 14 wherein the step of selecting includes determining a probability associated with each of the FMM segmentation of the overlapping ambiguity string and the BMM segmentation of the overlapping ambiguity string.

16. The method of claim 15 wherein determining the probabilities information comprises using an N-gram model.

17. The method of claim 16 wherein determining the probabilities comprises using probability information about a first word of the overlapping ambiguity string.

18. The method of claim 17 wherein determining the probabilities comprises using probability information about a last word of the overlapping ambiguity string.

19. The method of claim 16 wherein using the N-gram model comprises using information about context words around the overlapping ambiguity string.

20. The method of claim 16 wherein using the N-gram model comprises using information about a string of words comprising a first word of the overlapping ambiguity string and two context words to the left of the first word.

21. The method of claim 20 wherein using the N-gram model comprises using information about a string of words comprising a last word of the overlapping ambiguity string and two context words to the right of the last word.

22. The method of claim 15 wherein selecting includes using Naïve Bayesian Classifiers.

23. The method of claim 14 and further comprising receiving information from a lexical knowledge base comprising a trigram model.

24. The method of claim 23 and further comprising receiving an ensemble of Naïve Bayesian Classifiers.

25. A method of constructing information to resolve overlapping ambiguity strings in an unsegmented language comprising the steps of:
recognizing overlapping ambiguity strings in a training data;
replacing the overlapping ambiguity strings with tokens;
generating an N-gram language model comprising information on constituent words of the overlapping ambiguity strings.

26. The method of claim 25 wherein generating the N-gram language model comprises generating a trigram model.

27. The method of claim 25 and further comprising generating an ensemble of classifiers as a function of the N-gram model.

28. The method of claim 25 wherein recognizing the overlapping ambiguity strings comprises:
generating a Forward Maximum Matching (FMM) segmentation of each sentence in the training data;
generating a Backward Maximum Matching (BMM) segmentation of each sentence in the training data;
recognizing an OAS as a function of the FMM and the BMM segmentations of each sentence in the training data.

29. The method of claim 28 and further comprising generating an ensemble of classifiers as a function of the N-gram model.

30. The method of claim 29 wherein generating the ensemble of classifiers includes approximating probabilities of the FMM and BMM segmentations of each overlapping ambiguity string as being equal to the product of individual unigram probabilities of individual words in the FMM and BMM segmentations respectively, of the overlapping ambiguity string.

31. The method of claim 30 wherein generating the ensemble of classifiers includes approximating a joint probability of a set of context features conditioned on an existence of one of the segmentations of each overlapping ambiguity string as a function of a corresponding probability of a leftmost and a rightmost word of the corresponding overlapping ambiguity string.
